(19) United States
(12) Patent Application Publication
(10) Pub. No.: US 2007/0097090 A1
(43) Pub. Date: May 3, 2007

(54) Digital camera user interface

(76) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,630

(22) Filed: Oct. 31, 2005

(51) Int. Cl. G09G 5/00

(52) U.S. Cl. 345/173

(57) ABSTRACT

An exemplary user interface for a digital camera includes a first elongated button, a second elongated button and a third elongated scroll strip located between the first and second elongated buttons.

U.S. patent application Ser. No. ______, of Amy E. Battles (attorney docket no. 200506143-1), filed on the same day as this application, U.S. patent application Ser. No. ______, of Amy E. Battles, Daniel J. Byrne, Shanshan Li and Norman C. Pyle (attorney docket no. 200506156-1) filed on the same day as this application, U.S. patent application Ser. No. ______, of Amy E. Battles, Shanshan Li and Norman C. Pyle (attorney docket no. 200506158-1) filed on the same day as this application, U.S. patent application Ser. No. ______, of Amy E. Battles (attorney docket no. 200506125-1) filed on the same day as this application and U.S. patent application Ser. No. ______, of Mark J. Bianchi, Norman C. Pyle, Amy E. Battles, Shanshan Li and Daniel J. Byrne, (attorney docket no. 200506123-1) filed on the same day as this application, are all hereby incorporated by reference for all that is disclosed therein.

### BACKGROUND

As digital cameras get smaller, it becomes increasingly valuable to combine controls. One method that has been used in the past is to combine the zoom control (wide angle/telephoto) with arrow keys (either left/right or up/down). This works well for the most part, but causes problems in certain areas of the user interface where all four arrows and the zoom must be active at the same time. This occurs, for example, in the magnify view where the four arrows are used to pan around an image, while the zoom controls the level of magnification. It also occurs in thumbnail view where the four arrows are used to navigate around and select different thumbnails, while the zoom out is active to return to full-screen single-image view.

### BRIEF DESCRIPTION OF THE DRAWINGS

FIG. 1 is a front perspective view of an exemplary digital camera.

FIG. 2 is an elevation view of a rear face of the exemplary digital camera of FIG. 1.

FIG. 3 is a detail view of a portion of the digital camera rear face of FIG. 2 showing a user interface.

### DETAILED DESCRIPTION

An exemplary user interface for a digital camera is disclosed. The user interface may include a first elongated button having a central longitudinal axis extending in a first direction; a second elongated button having central longitudinal axis extending in a direction parallel to the first direction and an elongated scroll strip having a central longitudinal axis extending in a second direction transverse to the first direction. The elongated scroll strip may be located between the first elongated button and the second elongated button.

Also disclosed is an exemplary user interface for a digital camera in which the user interface includes a plurality of touchpad portions, each of the touchpad portions capable of specifying a distinct function of the digital camera. The plurality of touchpad portions may include a first elongated touchpad portion having a central longitudinal axis extending in a first direction; a second elongated touchpad portion having central longitudinal axis extending in a direction parallel to the first direction and a third elongated touchpad portion having a central longitudinal axis extending in a second direction transverse to the first direction. The third elongated touchpad portion may be located between the first elongated touchpad and the second elongated touchpad portion.

Also disclosed is an exemplary user interface for a digital camera in which the user interface may include a first elongated button; a second elongated button; an elongated scroll strip located between the first elongated button and the second elongated button; a third button located between the first elongated button and the elongated scroll strip and a fourth button located between the second elongated button and the elongated scroll strip. The first elongated button, the second elongated button, the third button, the fourth button and the elongated scroll strip may form a dumbbell configuration.

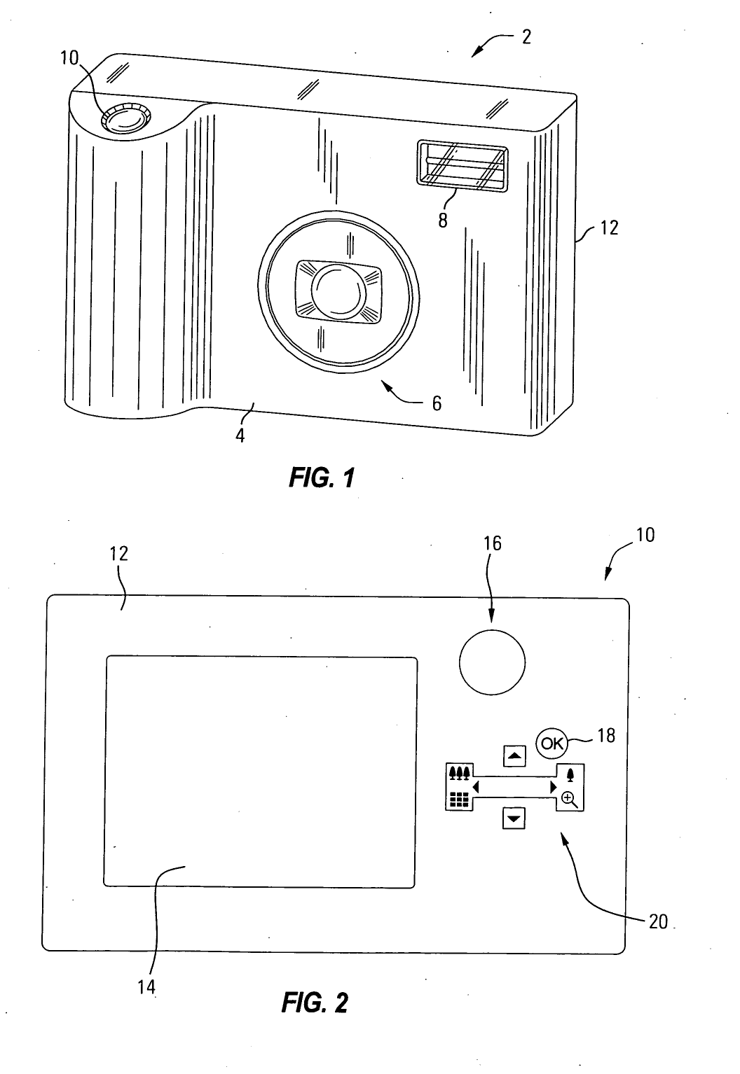

FIG. 1 illustrates an exemplary digital camera 2. The camera 2 may include a housing having a front face 4 and an oppositely disposed and generally parallel rear face 12. The digital camera 2 may include various devices related to the operation of the camera and features to facilitate user interface with the camera as will be readily understood by one skilled in the art. The camera 2 may, for example, include a lens assembly 6, a flash unit 8, and a shutter release button 10, as shown in FIG. 1.

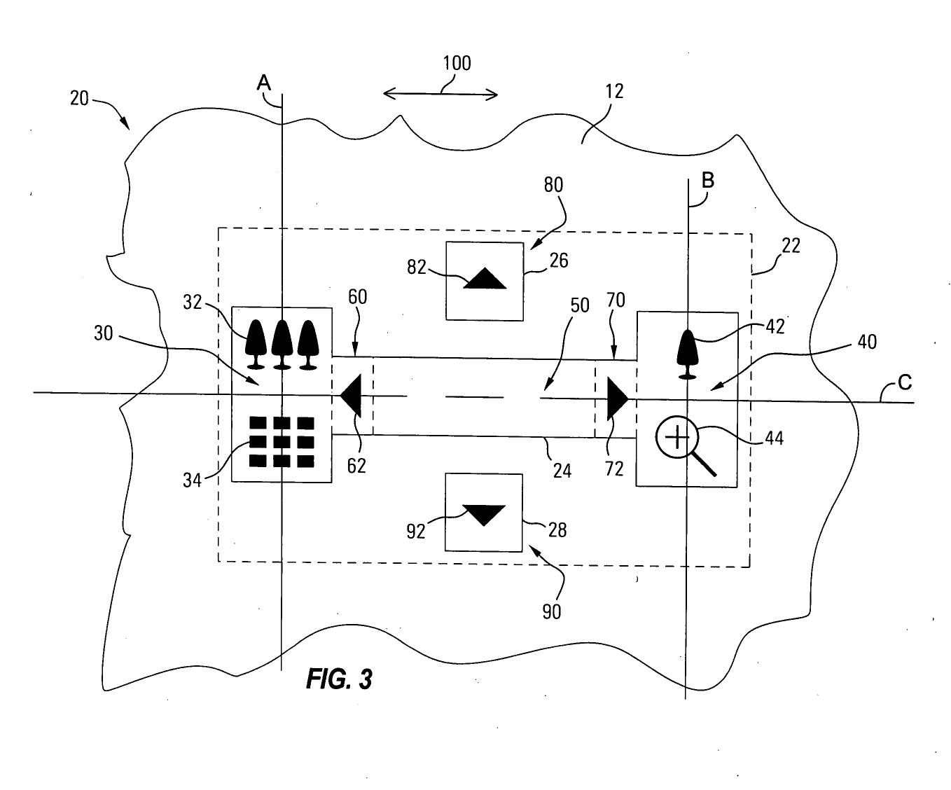

FIG. 2 illustrates the rear face 12 of the digital camera 2 in further detail. With reference to FIG. 2, a display 14 which may, for example, be a conventional LCD-type display, and a user interface 20 may be located on the rear face 12. A thumb rest 16 may also be located on the rear face 12 to provide the user of the camera with a place for his or her thumb when operating the camera to take a picture. A button 18 may be provided on the rear face 12, for example, to allow for user input.

It is noted that, although some features of the digital camera 2 have been described above, the camera will include other devices, not described or shown herein, related to the operation of the camera as will be readily understood by one skilled in the art. The camera may, for example, include an image capturing device (e.g., a CCD), a processor and other buttons and/or switches to facilitate user interface in a conventional manner.

FIG. 3 illustrates the user interface 20 in further detail. With reference to FIG. 3, the user interface 20 may include a conventional touchpad 22 located behind the rear face 12 of the camera 2. The rear face 12 may include various openings therein to define user accessible contact areas of the touchpad 22. Specifically, for example, a relatively large “dumbbell” shaped opening 24 may be provided as shown. A pair of smaller openings 26, 28 may be provided above and below the “handle” portion of the dumbbell shaped opening. Within each of the openings, one or more areas of the touchpad 22 may be defined as specific controls, e.g., as a button or a slider in a manner as will now be described in further detail. It is noted that, although the term “opening” is used herein, the openings in the rear face 12 may alternatively be covered with a material that effectively seals the camera housing but still allows the touchpad to sense a touch or press.

First through fifth touchpad portions may be provided within the opening 24 as follows. A first elongated touchpad portion may be provided having a central longitudinal axis “A”. A second elongated touchpad portion 40 may be provide having a central longitudinal axis “B” that may, for example, be parallel to the central longitudinal axis “A” of the first touchpad portion 30. A third elongated touchpad portion 50 may be provided between the first touchpad portion 30 and second touchpad portion 40, as shown. Third touchpad portion may have a central longitudinal axis “C” that may, for example, be perpendicular to the axes “A” and “B” of the first and second touchpad portions 30 and 40, respectively. A fourth touchpad portion 60 and a fifth touchpad portion 70 may be located on either side of the third touchpad portion 50 as shown. It is noted that the dashed lines delineating the touchpad portions 60 and 70 are provided in FIG. 3 only for purposes of facilitating this written description. In actual use, the touchpad portions 60 and 70 are preferably provided without any delineating lines, as generally shown in FIG. 2.

A sixth touchpad portion 80 may be provided within the opening 26 and a seventh touchpad portion 90 may be provided within the opening 28. Each of the touchpad portions described herein may be mapped, in a conventional manner, to one or more particular functions within the digital camera 2. The touchpad portions 30, 40, 60, 70, 80 and 90 may each be mapped to function as buttons such that when the user applies pressure to one of these areas (e.g., with a finger), it functions as would a conventional button. Accordingly, the touchpad portions 30, 40, 60, 70, 80 and 90 may hereinafter be referred to simply as “buttons”. The touchpad portion 50 may be mapped so as to function as a scroll strip such that movement of the user's finger along the touchpad portion 50 in the directions indicated by the arrow 100, may be sensed. Pressing on a particular area of the touchpad portion 50 can also be sensed. Accordingly, the touchpad portion 50 may hereinafter be referred to simply as a “scroll strip”.

As will be described in further detail herein, the touchpad portion 50 (scroll strip) is able to be used for different camera functions (e.g., controlling zoom versus panning or scrolling) at different times. This compliments the efficiency and compactness of the camera 2. At the same time, the design of the user interface 20 allows the user of the camera 2 to intuitively use the scroll strip 50 and select its functionality.

In operation, the digital camera 2 functions in one of at least two modes: “live mode” and “playback” mode. In live mode, the image currently being captured by the digital camera (i.e., via the lens and image capture device) would be displayed on the display 14, FIG. 2. The digital camera would generally be placed in live mode when it is desired to capture a still picture or a video clip. In playback mode, the display 14 would be used to display images or video clips previously captured and recorded by the digital camera 2.

When the digital camera 2 is in live mode, the buttons 30 and 40 function as zoom controls. Specifically, pressing and holding the button 30 will cause the camera 2 to zoom out while pressing and holding the button 40 will cause the camera to zoom in. The buttons 30 and 40 may include icons thereon indicative of the functions described above. The button 30 may, for example, include an icon 32 in the shape of a plurality of trees to suggest zooming out to a wider field of view. The button 40 may, for example, include an icon 42 in the shape of a single tree to suggest a narrower, more zoomed in, field of view. The button 40 may also include an icon 44 which may, for example, be in the form of a magnifying glass with a plus sign in the center to further indicate a zooming in function.

When in live mode, the user may alternatively slide a finger along the scroll strip 50 to achieve the same result as pressing the zoom buttons 30 and 40 as described above. Sliding the finger to the right, as viewed in FIG. 3, for example, causes the camera 2 to zoom in while sliding to the left causes the camera to zoom out. The user may also tap or press a specific area on the scroll strip 50 to cause the camera to “snap” to a particular zoom setting dictated by the location along the scroll strip that is tapped or pressed. Tapping the center of the scroll strip, for example, may cause the camera 2 to snap to a zoom position midway between its maximum and minimum zoom. Tapping a location 30% of the way from the left edge of the scroll strip to the right edge may cause the camera to snap to a zoom position equal to 30% of its maximum zoom, and so on.

Playback mode generally includes three sub-modes: regular playback sub-mode, zoomed view sub-mode and thumbnail view sub-mode.

In the regular playback sub-mode, the user scrolls through full-size images that have previously been captured by the camera and are stored in the camera's memory. In this sub-mode, the buttons 60 and 70 may be used to scroll backward and forward, respectively, through the images (generally, the images would be displayed either in the same order that they were captured or in reverse order, i.e., the last captured image would be displayed first). The buttons 60 and 70 (as well as the buttons 80 and 90) may include icons 62, 72, 82, 92, respectively, to indicate the directional function of each button. The icons may take the form of arrows as shown. As an alternative to using the arrow buttons 60 and 70, the user may slide a finger along the scroll strip 50 to achieve the same result as pressing the left and right arrow buttons 60, 70 as described above. Sliding the finger to the right, as viewed in FIG. 3, for example, causes the camera to scroll forward through the images, in the same manner as the arrow button 70 while sliding to the left causes the camera to scroll backward through the images, in the same manner as the arrow button 60. The user may also tap or press a specific area on the scroll strip 50 to cause the camera 2 to “snap” to the display of a captured image dictated by the location along the scroll strip that is tapped or pressed. Tapping the center of the scroll strip, for example, may cause the middle image to be displayed (if, for example, 25 images are stored in the camera's memory, the “middle” would be around the thirteenth image). Tapping a location 30% of the way from the left edge of the scroll strip to the right edge, for example, may cause the display to snap to the image that is about 30% from the beginning of the list of captured images (again, if, for example, 25 images are stored in the camera's memory, tapping around the 30% point would cause the seventh or eighth image to be displayed) and so on.

From the regular playback sub-mode, pressing or tapping the zoom in button 40 will cause the camera to enter the second playback sub-mode-zoomed view. Entering this sub-mode will zoom in on the image currently being displayed on the display 14. Once zoomed view sub-mode has been activated, the zoom buttons 30 and 40 may be pressed and held to zoom out or in, respectively and the function of the scroll strip 50 may also be changed to zoom (it is noted that, if the zoom out button 30 is continued to be held after maximum zoom out has been achieved, this may cause the camera to cycle to the thumbnail view sub-mode, possibly after a brief pause). Accordingly, after actuating the zoomed view sub-mode, as described above, the scroll strip 50 will cease to function as a directional control and will, instead, control zoom in a manner as described previously.

If it is desired to pan the image while in zoomed view sub-mode, the user may press any of the directional arrow buttons 60, 70, 80, 90 to pan in the direction indicated by the arrow icon. The scroll strip 50 will remain active for zoom control, as described above.

As an alternative to the scroll strip 50 remaining active for zoom control, the function of the scroll strip 50 may be changed from zoom to pan when one of the directional arrow buttons 60, 70, 80, 90 is pressed in zoomed view sub-mode. In this case, with the scroll strip 50 function set to pan, the user may slide a finger along the scroll strip 50 to achieve the same result as pressing the left and right arrow buttons 60, 70 as described above. Sliding the finger to the right, as viewed in FIG. 3, for example, may cause view displayed on the display to pan to the right while sliding to the left causes the view to pan left. The user may also tap or press a specific area on the scroll strip 50 to cause the displayed image to “snap” to a right and left location dictated by the location along the scroll strip that is tapped or pressed. Tapping the center of the scroll strip, for example, may cause the display to snap to the horizontal center of the image. Tapping a location 30% of the way from the left edge of the scroll strip to the right edge may cause the display to snap to a horizontal position 30% from the left edge of the image being displayed and so on. Pressing either of the zoom buttons 30, 40 will cause the function of the scroll strip 50 to change back to zoom, as described above. Accordingly pressing one of the zoom buttons 30, 40 may toggle the scroll strip to zoom function while pressing one of the arrow buttons 60, 70, 80, 90 may toggle the scroll strip to panning function.

To activate the third sub-mode, the thumbnail view sub-mode, the button 30 may be tapped (as opposed to pressed and held for zooming). The button 30 may include an icon 34 indicative of this function. Specifically, the icon 34 may be in the form of a plurality of rectangles suggestive of thumbnail view. While in thumbnail view sub-mode, the arrow buttons 60, 70, 80, 90 may be used to navigate through the thumbnail images. The scroll strip 50 may also be used to navigate left and right as an alternative to using the arrow buttons 60, 70. To exit thumbnail view, the user may tap (once again, as opposed to pressing and holding) the button 40.

The user interface 20 described herein provides an intuitive means of providing the scroll strip 50 with multi-functional capability.

The user interface 20 has been described herein as having a generally horizontal orientation. In other words, the axis “C” of the scroll strip 50 is horizontal as viewed in FIG. 3 and during normal operation of the camera 2. In an alternative exemplary embodiment (not shown), however, the user interface 20 could be formed having a vertical orientation, i.e., one in which the axis “C” of the scroll strip 50 would be vertical during normal operation of the camera 2. In this embodiment, the arrow buttons 80 and 90 would adopt left and right, respectively, panning functions and the arrow buttons 60 and 70 down and up, respectively panning functions. In panning mode, the scroll strip 50 would function to pan the image up and down, rather than right and left as described in conjunction with the previous embodiment. The zooming function of the scroll strip 50 would remain essentially the same except that zoom in would be in the upward direction instead of toward the right. The various icons on the buttons could, of course, be rotated as necessary to maintain their upright appearance.

It is noted that, although the up and down buttons 80 and 90 have been described herein as being portions of the touchpad 22, these could alternatively be formed as separate buttons extending from the surface of the rear face 12 of the camera 2, in a conventional manner. Further, although one relatively large touchpad 22 has been described for several buttons and the scroll strip 50, two or more smaller touchpads could alternatively be used to achieve the same functionality.

Although the scroll strip 50 has been described herein for controlling zoom and panning, it may also be alternatively or additionally used for other functions, e.g., exposure or focus control.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A user interface for a digital camera comprising:
a first elongated button having a central longitudinal axis extending in a first direction;
a second elongated button having central longitudinal axis extending in a direction parallel to said first direction;
an elongated scroll strip having a central longitudinal axis extending in a second direction transverse to said first direction; and
said elongated scroll strip is located between said first elongated button and said second elongated button.

2. The user interface of claim 1 and further comprising:
a third button located between said first elongated button and said elongated scroll strip; and
a fourth button located between said second elongated button and said elongated scroll strip.

3. The user interface of claim 2 and further wherein:
said first elongated button, said second elongated button, said third button, said fourth button and said elongated scroll strip form a dumbbell configuration.

4. The user interface of claim 1 and further wherein:
said second direction is perpendicular to said first direction.

5. The user interface of claim 1 and further wherein:
said elongated scroll strip controls zooming.

6. The user interface of claim 1 and further wherein:
said elongated scroll strip controls panning.

7. The user interface of claim 1 and further wherein:
said elongated scroll strip controls scrolling through images.

8. A user interface for a digital camera, said user interface comprising:
a plurality of touchpad portions, each of said touchpad portions capable of specifying a distinct function of said digital camera, said plurality of touchpad portions comprising:
a first elongated touchpad portion having a central longitudinal axis extending in a first direction;
a second elongated touchpad portion having central longitudinal axis extending in a direction parallel to said first direction;
a third elongated touchpad portion having a central longitudinal axis extending in a second direction transverse to said first direction; and
said third elongated touchpad portion located between said first elongated touchpad and said second elongated touchpad portion.

9. The user interface of claim 8 and further comprising:
a fourth touchpad portion located between said first elongated touchpad portion and said third elongated touchpad portion; and
a fifth touchpad portion located between said second elongated button and said third elongated touchpad portion.

10. The user interface of claim 9 and further wherein:
said first elongated touchpad portion, said second elongated touchpad portion, said third elongated touchpad portion, said fourth touchpad portion and said fifth touchpad portion form a dumbbell configuration.

11. The user interface of claim 8 and further wherein:
said second direction is perpendicular to said first direction.

12. The user interface of claim 8 and further wherein:
said third elongated touchpad portion controls zooming.

13. The user interface of claim 8 and further wherein:
said third elongated touchpad portion controls panning.

14. The user interface of claim 8 and further wherein:
said third elongated touchpad portion controls scrolling through images.

15. A user interface for a digital camera, said user interface comprising:
a first elongated button;
a second elongated button;
an elongated scroll strip located between said first elongated button and said second elongated button;
a third button located between said first elongated button and said elongated scroll strip;
a fourth button located between said second elongated button and said elongated scroll strip; and
wherein, said first elongated button, said second elongated button, said third button, said fourth button and said elongated scroll strip form a dumbbell configuration.

16. The user interface of claim 15 and further wherein:
said first elongated button has a central longitudinal axis extending in a first direction;
said second elongated button has a central longitudinal axis extending in a direction parallel to said first direction;
said elongated scroll strip has a central longitudinal axis extending in a second direction transverse to said first direction.

17. The user interface of claim 16 and further wherein:
said second direction is perpendicular to said first direction.

18. The user interface of claim 15 and further wherein:
said elongated scroll strip controls zooming.

19. The user interface of claim 15 and further wherein:
said elongated scroll strip controls panning.

20. The user interface of claim 15 and further wherein:
said elongated scroll strip controls scrolling through images.
